(19) United States
(12) Patent Application Publication
(10) Pub. No.: US 2026/0269668 A1
(43) Pub. Date: Sep. 10, 2026

(54) EMBEDDED MAGNET MOTOR

(71) Applicant: KABUSHIKI KAISHA TOSHIBA, Tokyo (JP)

(72) Inventors: Shogo SHINTANI, Yokohama (JP); Minoru AWAZU, Yokohama (JP)

(73) Assignee: KABUSHIKI KAISHA TOSHIBA, Tokyo (JP)

(21) Appl. No.: 19/167,670

(22) PCT Filed: Oct. 18, 2023
(86) PCT No.: PCT/JP2023/037713

§ 371 Date: Sep. 22, 2025

(30) Foreign Application Priority Data
Apr. 3, 2023 (JP) 2023-060182

(51) Int. Cl. H02K 1/274; H02K 1/16

(52) U.S. Cl. CPC H02K 1/274; H02K 1/16; H02K 2213/03

(57) ABSTRACT

An embedded magnet motor 1 according to an embodiment includes a permanent magnet 9 inserted in a magnet hole 11 provided in a rotor core 8, an open-type air gap portion 18 connected from the magnet hole 11 to an outer peripheral surface of the rotor core 8, and a magnet holding portion 20 that is in contact with a side surface of the permanent magnet 9, and forms, on the side surface, a closed-type air gap portion 19 that is not connected to the outer peripheral surface of the rotor core 8.

### TECHNICAL FIELD

The present disclosure relates to an embedded magnet motor.

### BACKGROUND ART

Hitherto, in an embedded magnet motor in which a permanent magnet is disposed inside a rotor core, an air gap portion called a flux barrier is provided around the permanent magnet to block a magnetic flux. In this case, when a magnetic flux that flows by a demagnetizing field generated by a stator coil passes through the air gap portion, passage of the magnetic flux in a corner portion of the permanent magnet causes demagnetization. Thus, proposals have been made to reduce the demagnetization by, for example, forming the air gap portion connected to a magnet hole so as to be partially narrowed in width as in Patent Literature 1, providing a large number of air gap portions around the magnet hole as in Patent Literature 2, or filling the air gap portion with a non-magnetic resin.

### CITATION LIST

### Patent Literature

Patent Literature 1: Japanese Patent Laid-Open No. 2014-155242
Patent Literature 2: Japanese Patent Laid-Open No. 2017-123779

### SUMMARY OF INVENTION

### Technical Problem

Meanwhile, from the viewpoint of blocking the magnetic flux, providing the air gap portion connected from the magnet hole to an outer peripheral surface of the rotor core is considered to be effective. Hereinafter, the air gap portion connected from the magnet hole to the outer peripheral surface of the rotor core is referred to as an open-type air gap portion.

However, in a case of a configuration in which the open-type air gap portion is provided, even if a part of the open-type air gap portion is formed to be narrowed in width, the torque may reduce. Further, when the number of air gap portions provided around the permanent magnet is increased, the inductance may reduce to reduce the torque. Further, when the air gap portion is filled with a non-magnetic material, the cost increases.

The present disclosure has been made in view of the above-mentioned circumstances, and has an object to provide an embedded magnet motor with which, in a configuration including an open-type air gap portion, demagnetization of a permanent magnet can be reduced while reduction in torque and increase in cost are prevented.

### Solution to Problem

An embedded magnet motor according to one aspect of the present disclosure includes a permanent magnet inserted in a magnet hole provided in a rotor core, an open-type air gap portion connected from the magnet hole to an outer peripheral surface of the rotor core, and a magnet holding portion that is in contact with a side surface of the permanent magnet and forms, on the side surface, a closed-type air gap portion that is not connected to the outer peripheral surface of the rotor core.

### BRIEF DESCRIPTION OF DRAWINGS

FIG. 1 is a view schematically illustrating an embedded magnet motor of an embodiment in a state as viewed from an axial direction.

FIG. 2 is a view illustrating a region II of FIG. 1 in an enlarged manner.

FIG. 3 is a view illustrating a region III of FIG. 2 in an enlarged manner.

FIG. 4 is a view illustrating a flow of a leakage magnetic flux in comparison with a conventional structure example.

FIG. 5 is a view illustrating a demagnetization factor distribution in comparison with the conventional structure example.

FIG. 6 is a view illustrating a shape change example of a magnet holding portion.

FIG. 7 is a graph illustrating a relationship between a holding portion angle and torque and a demagnetization factor.

FIG. 8 is a view illustrating a relationship between the holding portion angle and a magnetic path.

FIG. 9 is a first view illustrating another shape example of the magnet holding portion.

FIG. 10 is a second view illustrating another shape example of the magnet holding portion.

FIG. 11 is a third view illustrating another shape example of the magnet holding portion.

FIG. 12 is a fourth view illustrating another shape example of the magnet holding portion.

FIG. 13 is a fifth view illustrating another shape example of the magnet holding portion.

### DESCRIPTION OF EMBODIMENTS

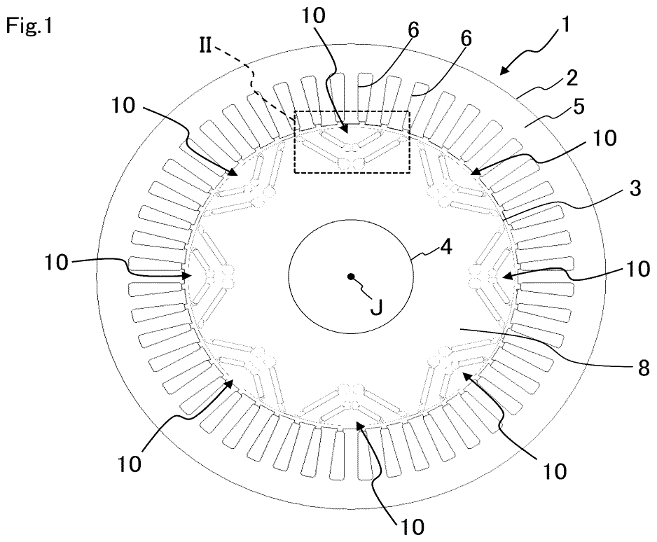

Hereinafter, an embodiment is described with reference to the drawings. As illustrated in FIG. 1, an embedded magnet motor 1 of this embodiment includes a stator 2, a rotor 3, and a shaft 4. Hereinafter, a direction along a rotary axis (J) of the rotor 3 is referred to as an axial direction, a direction about the rotary axis (J) is referred to as a circumferential direction, and a direction from the rotary axis (J) along an outer periphery of the rotor 3 is referred to as a radial direction. The stator 2 and the rotor 3 are accommodated in a case which is not shown, and the case is provided with a bearing member such as a bearing that supports the shaft 4 to be rotatable.

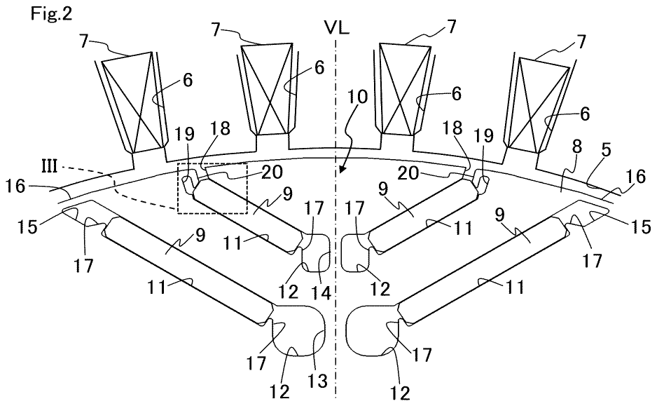

The stator 2 includes a stator core 5 formed to a substantially hollow cylindrical shape by stacking electromagnetic steel sheets having a predetermined shape in the axial direction, and a coil 7 inserted in a slot 6 formed in an inner peripheral surface of the stator core 5 as illustrated in FIG. 2. A plurality of slots 6 are formed in the inner peripheral surface of the stator 2 at predetermined intervals in the circumferential direction in a state of penetrating the stator 2 in the axial direction. The coil 7 is fixed to the stator core 5 by winding an element wire such as an enameled wire to the slots 6, or by mounting an element wire in a state of being wound in advance to the slots 6. It is to be noted that the coil 7 may have a configuration using a bus bar.

The rotor 3 includes a rotor core 8 formed to a substantially hollow cylindrical shape by, for example, stacking electromagnetic steel sheets punched into a predetermined shape in the axial direction, and a plurality of permanent magnets 9 disposed inside the rotor core 8. The shaft 4 is fixed in a hollow part of the rotor core 8 by, for example, press fitting, and rotates integrally with the rotor 3 relative to the stator core 5 about the rotary axis (J).

The permanent magnet 9 is, as illustrated in FIG. 2, formed to a substantially rectangular shape in a state as viewed from the axial direction of the rotor core 8, and includes short side surfaces that are relatively short and long side surfaces that are relatively long. In this embodiment, the permanent magnets 9 are substantially equal in length in the shorter direction, while permanent magnets 9 disposed on an inner peripheral side of a multilayer structure are longer in the longer direction. Further, each permanent magnet 9 is magnetized along the shorter direction. In this embodiment, the permanent magnet 9 adopts a shape in which a corner portion is chamfered to be flat, but this shape is merely an example, and it is also possible to adopt a shape in which the corner portion is not chamfered or a shape in which the corner portion is chamfered to be curved.

Those permanent magnets 9 are disposed in a state of being paired at positions that are linearly symmetrical with respect to an imaginary line (VL) passing through the rotary axis (J), in a substantially V-shape having a distance therebetween that is relatively short on the radially inner side and a distance therebetween that is relatively long on the radially outer side. Further, in this embodiment, the pairs of permanent magnets 9 are disposed side by side along the radial direction. Hereinafter, a structure in which the pairs of permanent magnets 9 are disposed side by side in the radial direction is referred to as a multilayer structure for the sake of convenience, and a plurality of permanent magnets 9 constituting the multilayer structure is also referred to as a magnet group for the sake of convenience. In the case of FIG. 2, four permanent magnets 9 constitute one magnet group of the multilayer structure.

The magnet groups are, as illustrated in FIG. 1, disposed at positions obtained by dividing the rotor core 8 into eight equal parts in the circumferential direction. At this time, adjacent magnet groups are disposed so that the magnetization directions of the permanent magnets 9 become alternately opposite. Accordingly, the embedded magnet motor 1 has eight magnetic poles 10 formed at equal positions in the circumferential direction. However, the structure illustrated in FIG. 1 and FIG. 2 is merely an example, and the shape and number of the slots 6, the number and arrangement of the magnetic poles 10 of the rotor 3, the shape of the permanent magnet 9, and the like are not limited to ones described above.

The permanent magnets 9 are respectively inserted into a plurality of magnet holes 11 formed in the rotor core 8. In addition, each magnet hole 11 is connected to an air gap portion for forming a flux barrier. Specifically, each magnet hole 11 is connected to an inner air gap portion 12 on the radially inner side, that is, on the imaginary line (VL) side which is the center of the magnetic pole 10. This inner air gap portion 12 is of a closed type that is not connected to the outer peripheral surface of the rotor core 8. In addition, a first bridge portion 13 along the imaginary line (VL) is formed between the inner air gap portions 12 that are on the outer peripheral side in the multilayer structure. Further, a second bridge portion 14 along the imaginary line (VL) is formed between the inner air gap portions 12 that are on the inner peripheral side in the multilayer structure.

Further, each magnet hole 11 positioned on the inner peripheral side in the multilayer structure is connected to an outer air gap portion 15 on the radially outer side, that is, on the side opposite to the imaginary line (VL). An outer periphery bridge portion 16 is formed on the outer peripheral side of the outer air gap portion 15. That is, the outer air gap portion 15 is of a closed type that is not connected to the outer peripheral surface of the rotor core 8. Further, the inner air gap portion 12 and the outer air gap portion 15 each have a protruding portion 17 formed therein. The protruding portion 17 extends along a side surface of the permanent magnet 9 and is in contact with the permanent magnet 9 to hold the permanent magnet 9 at a predetermined position.

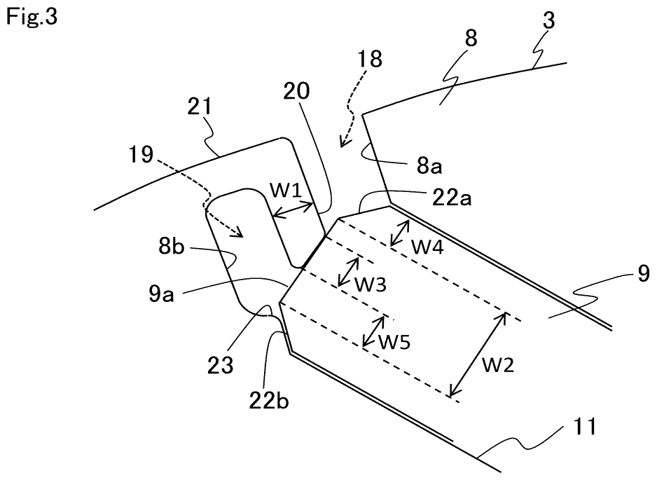

Meanwhile, the magnet hole 11 positioned on the outer peripheral side in the multilayer structure is connected to, on the radially outer side, as illustrated in FIG. 3, an open-type air gap portion 18 that is connected from the magnet hole 11 to the outer peripheral surface of the rotor core 8, and a closed-type air gap portion 19 that is connected to the magnet hole 11 but not connected to the outer peripheral surface of the rotor core 8. It is to be noted that FIG. 3 illustrates a state in which a gap is intentionally provided between the permanent magnet 9 and the magnet hole 11 to make the drawing more visible.

In addition, a magnet holding portion 20 is provided to partition a space between the open-type air gap portion 18 and the closed-type air gap portion 19. The magnet holding portion 20 is connected to a coupling bridge portion 21 obtained by extending a part of the outer peripheral surface of the rotor core 8, and forms, on a side surface of the permanent magnet 9 on the open-type air gap portion 18 side, the closed-type air gap portion 19 that is surrounded by the magnet holding portion 20, the coupling bridge portion 21, and the rotor core 8 and is connected to the magnet hole 11 but is not connected to the outer peripheral surface of the rotor core 8. Hereinafter, the short side surface of the permanent magnet 9 that is in contact with the magnet holding portion 20 is referred to as a short side surface 9a for the sake of convenience.

The magnet holding portion 20 has a width (W1) formed to be equal to or smaller than a width (W2) of the short side surface 9a of the permanent magnet 9, and is in contact with the short side surface 9a in a range of a predetermined width (W3). Further, on the open-type air gap portion 18 side, the magnet holding portion 20 is in contact with the short side surface 9a at a position that does not overlap a chamfered portion 22a of the permanent magnet 9. Accordingly, between the contact position of the magnet holding portion 20 and the inner surface of the magnet hole 11, there is a gap that is equal to or larger than an apparent width (W4) of the chamfered portion 22a when viewed from the short side surface 9a side.

Meanwhile, on the closed-type air gap portion 19 side, in this embodiment, the magnet holding portion 20 is in contact with the short side surface 9a on an inner side of an intersection between the short side surface 9a and a chamfered portion 22b. Accordingly, the short side surface 9a of the permanent magnet 9 is exposed to the closed-type air gap portion 19 in a predetermined width (W5) between the contact position of the magnet holding portion 20 and the chamfered portion 22b.

Further, the magnet holding portion 20 is formed to a rectangular shape that is substantially a rectangle except for a part that comes into contact with the permanent magnet 9. In addition, a corner portion of the magnet holding portion 20, a connection part between the magnet holding portion 20 and the coupling bridge portion 21, a connection part between the coupling bridge portion 21 and the rotor core 8, and the like are chamfered into a curved shape by being subjected to so-called fillet machining. This relaxes concentration of a stress at the corner portion and the connection parts. Further, the magnet holding portion 20 is formed to be substantially parallel to a wall surface 8a of the rotor core 8 that forms the open-type air gap portion 18, and a wall surface 8b of the rotor core 8 that forms the closed-type air gap portion 19.

Further, for the chamfered portion 22b of the permanent magnet 9, an auxiliary holding portion 23 to be in contact with the chamfered portion 22b is provided by causing a part of the rotor core 8 to protrude. Thus, a stress to be applied to the magnet holding portion 20, the coupling bridge portion 21, and the like is reduced. It is to be noted that the width (W1) of the magnet holding portion 20, the width (W3) to be in contact with the short side surface 9a, and the positional relationship or range of contact with the short side surface 9a described above are merely examples, and can be set as appropriate based on the size and shape of the permanent magnet 9 so as to have a strength that makes it possible to hold the permanent magnet 9.

Next, actions and effects of the above-mentioned configuration are described.

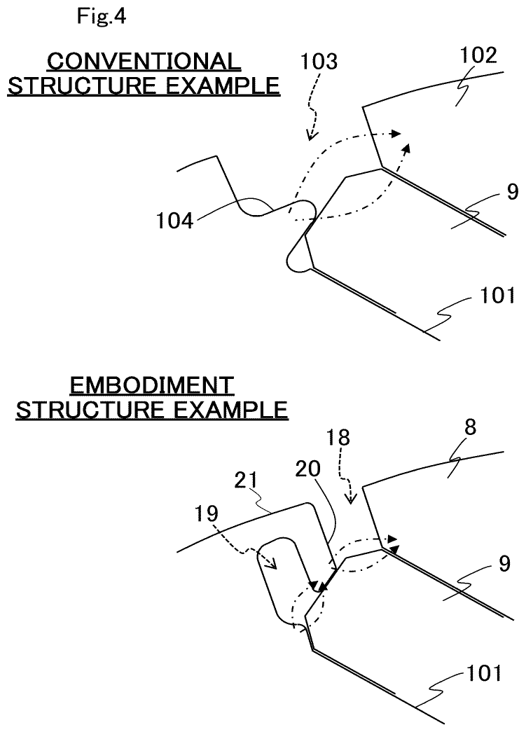

As described above, from the viewpoint of blocking the magnetic flux, as illustrated in FIG. 4 as a conventional structure example, providing an air gap portion 103 connected from a magnet hole 101 to an outer peripheral surface of a rotor core 102 is considered to be effective. Meanwhile, when the open-type air gap portion 103 is provided, a flow of a magnetic flux indicated by the long dashed short dashed line greatly bulges outward, and, along therewith, the permanent magnet 9 is demagnetized further to the inside.

Further, for example, when a part of the air gap portion 103 is formed to be narrowed in width to allow the air gap portion 103 to also serve as a holding structure 104 for the permanent magnet 9, demagnetization is reduced, but there is a problem that the torque reduces. Further, when a large number of air gaps are provided around the permanent magnet 9, the inductance reduces to reduce the torque. Further, filling the air gap portion 103 with a non-magnetic material increases cost.

In view of the above, in this embodiment, in the configuration including the open-type air gap portion 18, the demagnetization of the permanent magnet 9 is reduced while the reduction in torque and the increase in cost are prevented.. Specifically, as illustrated in FIG. 4 as an embodiment structure example, in addition to the open-type air gap portion 18, the magnet holding portion 20 that is in contact with the side surface of the permanent magnet 9 and forms, on the side surface, the closed-type air gap portion 19 that is not connected to the outer peripheral surface of the rotor core 8 is provided. This makes it possible to reduce a leakage magnetic flux indicated by the broken line, to reduce bulging of the magnetic flux, and to reduce the demagnetization. This is because the magnetic path of the air gap portion is shorter than that when only the open-type air gap portion 18 is provided.

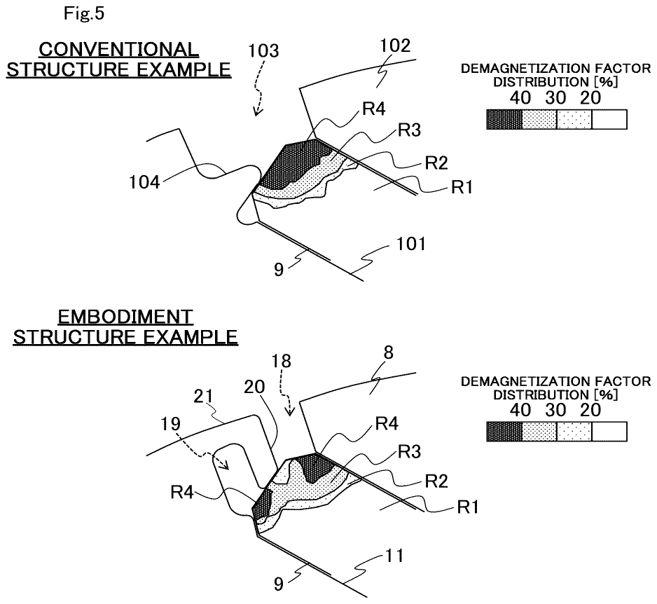

FIG. 5 illustrates simulation results of a demagnetization factor distribution in the conventional structure example and the embodiment structure example. It is to be noted that FIG. 5 illustrates a region (R1) in which the demagnetization factor is less than 20%, a region (R2) in which the demagnetization factor is in a range of 20% to 30%, a region (R3) in which the demagnetization factor is in a range of 30% to 40%, and a region (R4) in which the demagnetization factor exceeds 40%, in a divided manner.

As understood from the simulation results, in the case of the embodiment structure example, the region (R4) in which the demagnetization factor exceeds 40% is significantly smaller than that in the conventional structure example, and the demagnetization is reduced. In addition, when the demagnetization factor in the conventional structure example is represented by X [%] and the torque is represented by Y [Nm], in the embodiment structure example, such a result that the demagnetization factor is smaller than X and the torque is larger than Y is obtained, and both of the demagnetization factor and the torque can be improved. That is, with a configuration as in the embodiment structure example, it is possible to achieve a good balance between performances of the flux barrier, the torque, and the demagnetization factor, which are all related to each other and may be in a trade-off relationship, and it is possible to improve both of the demagnetization factor and the torque. It is to be noted that the demagnetization factor represented by X is obtained based on a rate of decrease of a peak value of an induced voltage before and after the demagnetization.

According to the embodiment described above, the following effects can be obtained.

The embedded magnet motor 1 includes the permanent magnet 9 inserted in the magnet hole 11 provided in the rotor core 8, the open-type air gap portion 18 connected from the magnet hole 11 to the outer peripheral surface of the rotor core 8, and the magnet holding portion 20 that is in contact with the side surface of the permanent magnet 9, and forms, on the side surface, the closed-type air gap portion 19 that is not connected to the outer peripheral surface of the rotor core 8. This makes it possible to, in the configuration including the open-type air gap portion 18, reduce the leakage magnetic flux and further reduce bulging when the leakage magnetic flux flows, and also reduce the demagnetization of the permanent magnet 9 while preventing reduction in torque and increase in cost.

Further, the magnet holding portion 20 is in contact with the side surface of the permanent magnet 9 on the radially outer side in a state as viewed from the axial direction that is the rotation center of the rotor core 8. This makes it possible to reduce the demagnetization factor in a part of the permanent magnet 9 that is easily demagnetized.

Further, the permanent magnet 9 is formed to a shape including, in the state as viewed from the axial direction that is the rotation center of the rotor core 8, a short side surface that is relatively short and a long side surface that is relatively long, and the magnet holding portion 20 is in contact with the short side surface of the permanent magnet 9. This makes it possible to reduce the demagnetization factor in the part of the permanent magnet 9 that is easily demagnetized.

Further, a plurality of the permanent magnets 9 are provided side by side in the radial direction of the rotor core 8, and the magnet holding portion 20 is provided to correspond to at least one permanent magnet 9 out of the plurality of the permanent magnets 9. In this embodiment, the magnet holding portion 20 is provided to correspond to the permanent magnet 9 present on the most radially outer side. This makes it possible to reduce the demagnetization factor at a position at which the open-type air gap portion 18 is assumed to be provided.

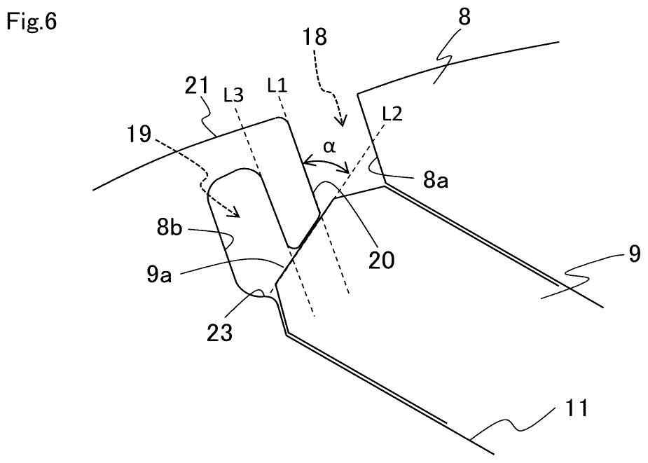

Incidentally, the magnet holding portion 20 is not limited to the shape exemplified in FIG. 3, and can have other shapes. For example, as illustrated in FIG. 6, an angle (α) formed between a line segment (L1) along the short side surface 9a of the permanent magnet 9 in a state as viewed from the axial direction and a line segment (L2) along a straight part of a side surface of the magnet holding portion 20 on the open-type air gap portion 18 side can be changed. Hereinafter, the angle (α) formed between the line segment (L1) and the line segment (L2) is referred to as a holding portion angle for the sake of convenience, and description is given assuming that a center side of the magnetic pole 10 is 0 degrees.

At this time, the line segment (L2) is substantially parallel to the wall surface 8a of the rotor core 8 forming the open-type air gap portion 18, and a line segment (L3) along a straight part of a side surface of the magnet holding portion 20 on the closed-type air gap portion 19 side is substantially parallel to the wall surface 8b of the rotor core 8 forming the closed-type air gap portion 19. Further, the line segment (L2) and the line segment (L3) are substantially parallel.

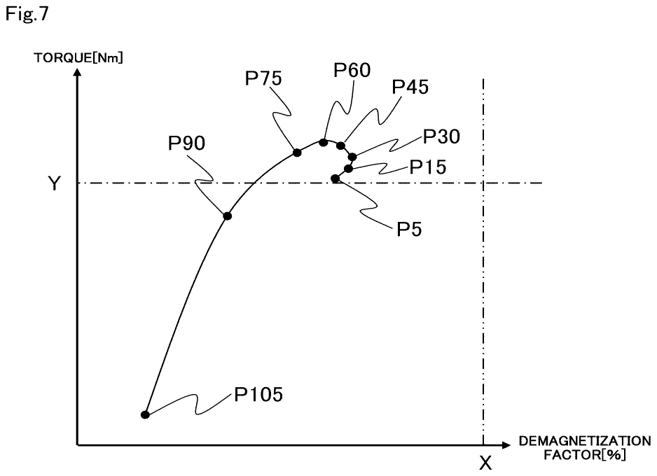

FIG. 7 illustrates a relationship between the torque and the demagnetization factor when the holding portion angle is changed from 5 degrees to 105 degrees. It is to be noted that, for example, a point (P5) illustrated in FIG. 7 indicates a result when the holding portion angle is 5 degrees, and a point (P15) indicates a result when the holding portion angle is 15 degrees. The same holds true for the other points. Further, an auxiliary line provided at a position at which the demagnetization factor is X [%] and an auxiliary line provided at a position at which the torque is Y [Nm] both indicate the demagnetization factor and the torque in the conventional structure example illustrated in FIG. 4.

From the results of FIG. 7, it can be understood that the demagnetization factor is improved compared to the conventional structure regardless of the holding portion angle. This is due to the provision of the magnet holding portion 20. Meanwhile, it can be understood that the torque is improved compared to the conventional structure when the holding portion angle is in a range of approximately 5 degrees to 80 degrees. Further, it can also be understood that, when the holding portion angle is in a range of approximately up to about 90 degrees, it is possible to obtain torque at the same level as the conventional structure example, and also improve the demagnetization factor.

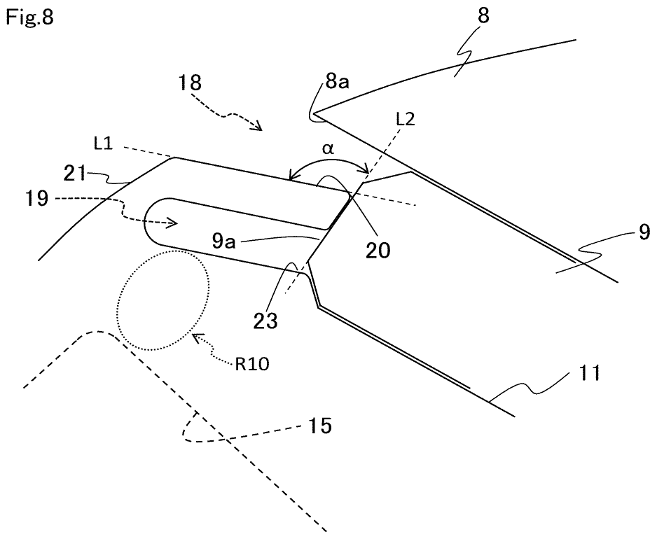

Further, the torque starts to decrease when the holding portion angle exceeds 75 degrees, and greatly decreases at 105 degrees, but this is not thought to be a problem of the holding portion angle. That is, it is considered that, when the holding portion angle is set to approximately 105 degrees, as indicated by the broken line in FIG. 8, a narrow width region (R10) having a narrow width with respect to the outer air gap portion 15 positioned on the inner peripheral side of the multilayer structure is formed, with the result that the q-axis magnetic path is narrowed and magnetic saturation is caused.

Accordingly, for example, when a magnetic path can be secured as in the configuration in which the magnet holding portion 20 is provided to correspond to the permanent magnet 9 on the inner peripheral side in the multilayer structure, it is considered that the torque can be improved even if the holding portion angle is set to 105 degrees.

Further, from those results, it is considered that the demagnetization factor can be reduced by setting the holding portion angle in a range of approximately about 5 degrees to 105 degrees, more preferably in a range of approximately about 5 degrees to 90 degrees, further more preferably in a range of approximately about 5 degrees to 80 degrees.

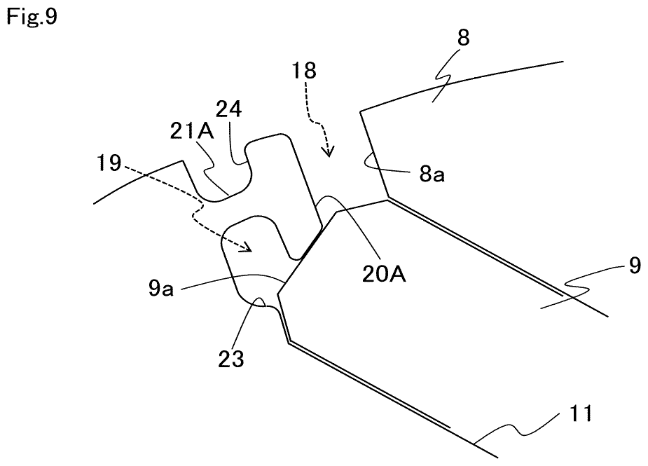

Further, the magnet holding portion 20 can also be modified in its shape in addition to the above-mentioned holding portion angle. For example, as illustrated in FIG. 9, it is possible to employ a configuration in which a coupling bridge portion 21A is positioned between the short side surface 9a of the permanent magnet 9 and the outer peripheral surface of the rotor core 8, and a magnet holding portion 20A connected to the coupling bridge portion 21A is provided. In this case, it is also possible to employ a configuration in which the coupling bridge portion 21A is provided with an auxiliary air gap portion 24 recessed from the outer peripheral surface of the rotor core 8. Even with this configuration, it is possible to obtain effects similar to those of the above-mentioned embodiment structure example, such as reducing demagnetization of the permanent magnet 9 while preventing reduction in torque and increase in cost in the configuration including the open-type air gap portion 18.

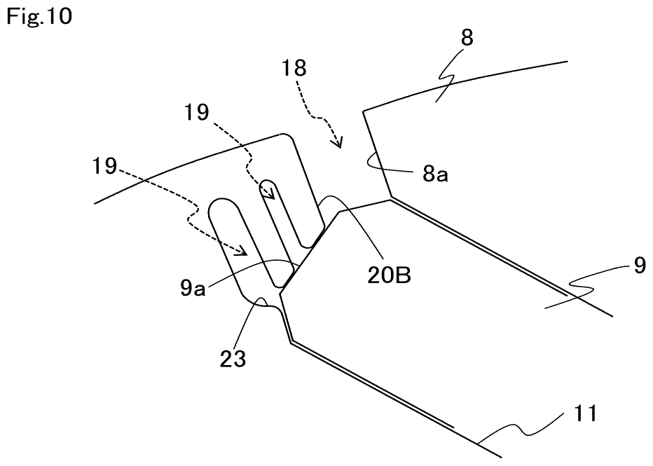

Further, as illustrated in FIG. 10, it is possible to employ a configuration in which a magnet holding portion 20B that forms a plurality of closed-type air gap portions 19 is provided on the short side surface 9a of one permanent magnet 9. Even with this configuration, it is possible to obtain effects similar to those of the above-mentioned embodiment structure example, such as reducing demagnetization of the permanent magnet 9 while preventing reduction in torque and increase in cost in the configuration including the open-type air gap portion 18.

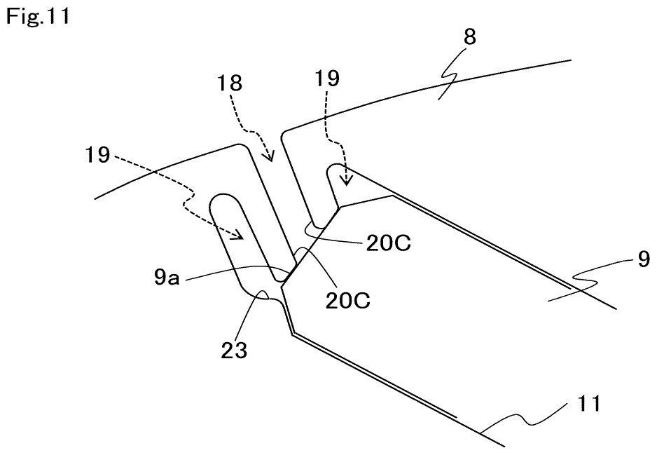

Further, as illustrated in FIG. 11, it is possible to employ a configuration in which a plurality of magnet holding portions 20C are provided on the short side surface 9a of one permanent magnet 9 to each form the closed-type air gap portion 19. Even with this configuration, it is possible to obtain effects similar to those of the above-mentioned embodiment structure example, such as reducing demagnetization of the permanent magnet 9 while preventing reduction in torque and increase in cost in the configuration including the open-type air gap portion 18.

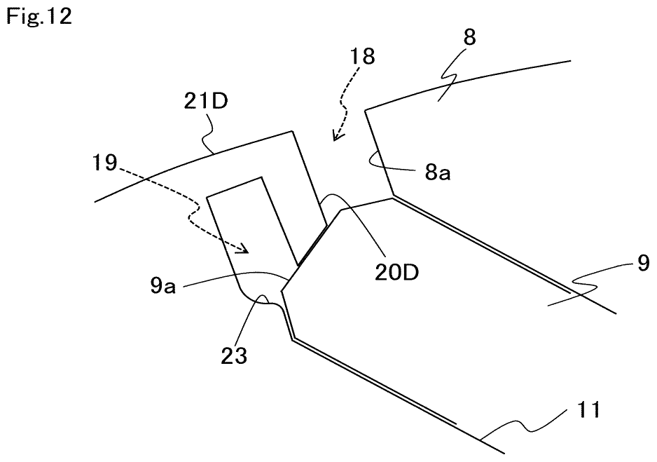

Further, as illustrated in FIG. 12, it is possible to employ a configuration in which a magnet holding portion 20D and a coupling bridge portion 21D having corner portions that are not subjected to fillet machining are provided, on the premise that a required strength is ensured by the strength design. In this case, it is also possible to employ a configuration in which some corner portions are subjected to fillet machining. Even with this configuration, it is possible to obtain effects similar to those of the above-mentioned embodiment structure example, such as reducing demagnetization of the permanent magnet 9 while preventing reduction in torque and increase in cost in the configuration including the open-type air gap portion 18.

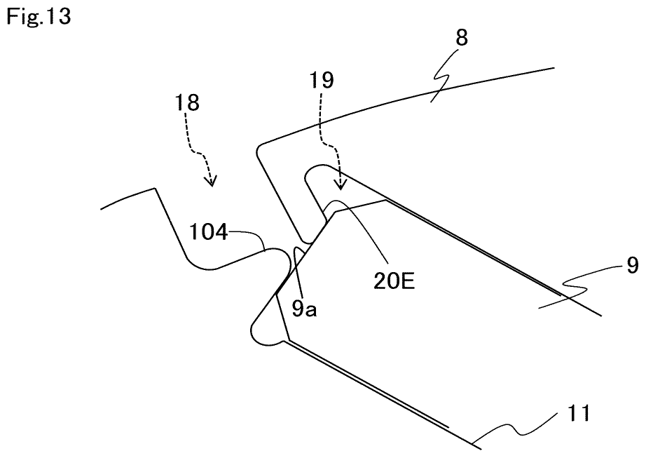

Further, as illustrated in FIG. 13, it is possible to employ a configuration in which a magnet holding portion 20E is provided to a conventional structure illustrated in FIG. 4. In this case, it is considered that the conventional holding structure 104 is provided in a state that makes it possible to hold the permanent magnet 9, and hence the design flexibility of the strength calculation, the shape, the dimension, the contact area, and the like of the magnet holding portion 20E can be enhanced. Even with this configuration, it is possible to obtain effects similar to those of the above-mentioned embodiment structure example, such as reducing demagnetization of the permanent magnet 9 while preventing reduction in torque and increase in cost in the configuration including the open-type air gap portion 18. Further, although the illustration is omitted, the shape examples illustrated in FIG. 9 to FIG. 13 can be combined with each other to the extent that they do not conflict. Further, they can also be applied to the permanent magnet 9 having a shape in which the corner portion is not chamfered.

The embodiments described above are presented as examples and are not intended to limit the scope of the invention. Those novel embodiments can be implemented in various other forms, and various omissions, substitutions, and modifications can be made without departing from the gist of the invention. The embodiments and modifications thereof are within the scope and gist of the invention, and are included in the scope of the invention and its equivalents as set forth in the claims.

1. An embedded magnet motor comprising:
a permanent magnet inserted in a magnet hole provided in a rotor core;
an open-type air gap portion connected from the magnet hole to an outer peripheral surface of the rotor core; and
a magnet holding portion that is in contact with a side surface of the permanent magnet and forms, on the side surface, a closed-type air gap portion that is not connected to the outer peripheral surface of the rotor core.

2. The embedded magnet motor according to claim 1, wherein the magnet holding portion is in contact with a side surface of the permanent magnet on a radially outer side in a state as viewed from an axial direction that is a rotation center of the rotor core.

3. The embedded magnet motor according to claim 1, wherein
the permanent magnet is formed to a shape including, in a state as viewed from an axial direction that is a rotation center of the rotor core, a short side surface that is relatively short and a long side surface that is relatively long, and
the magnet holding portion is in contact with the short side surface of the permanent magnet.

4. The embedded magnet motor according to claim 1, wherein
a plurality of the permanent magnets are provided side by side in a radial direction of the rotor core, and
the magnet holding portion is provided to correspond to at least one permanent magnet out of the plurality of the permanent magnets.

5. The embedded magnet motor according to claim 1, wherein the magnet holding portion forms a plurality of the closed-type air gap portions on the side surface of one of the permanent magnets.

6. The embedded magnet motor according to claim 1, wherein a plurality of the magnet holding portions are provided on the side surface of one of the permanent magnets.
